(19) United States
(12) Patent Application Publication
(10) Pub. No.: US 2007/0120303 A1
(43) Pub. Date: May 31, 2007

(54) Vehicle suspension system

(75) Inventor: Jackv Rhein, Yerres (FR)

Correspondence Address: CONNOLLY BOVE LODGE & HUTZ LLP, P.O. BOX 2207, WILMINGTON, DE, 19899-2207, US

(73) Assignee: ALLEVARD REJNA AUTOSUSPENSIONS French Stock Company, Saint-Cloud (FR)

(21) Appl. No.: 10/575,167

(22) PCT Filed: Oct. 11, 2004
(86) PCT No.: PCT/FR04/02564

§ 371 Date: Apr. 10, 2006

(30) Foreign Application Priority Data
Oct. 9, 2003 (FR) 0311814

(51) Int. Cl. F16F 1/04; B60G 9/00

(52) U.S. Cl. 267/286; 280/124.179; 267/248

(57) ABSTRACT

A vehicle suspension including a subassembly comprising a coil spring mounted between two supports of variable spacing. One of the supports (18) is constrained to move along a trajectory that is curved relative to the other support, and the pitch of an end portion of the corresponding end turn (20a) of the spring (12) varies in a manner that is negative or zero.

The invention relates to a vehicle suspension, in particular a trailed-arm suspension, and it relates more particularly to an improvement to a spring for such a suspension, enabling the compression of the spring to be controlled better.

The invention applies to any suspension in which a spring is installed to bear between two supports at a variable spacing and in which at least one of the supports is constrained to move along a curved trajectory relative to the other. This applies in particular to a so-called “trailed-arm” suspension. For example, one of the supports can be secured to the chassis and the other can be defined by an arm hinged to said chassis.

When the open angles are large (i.e. when the stroke of the suspension is large), retaining the spring leads to technical problems that are not negligible. In particular, a coil spring mounted between two supports of this kind becomes naturally curved between the two bearing points, and contact between the end turns of the spring and said supports ceases to be satisfactory, sometimes taking place via a single point when the suspension is in the relaxed position (i.e. while the wheel is hanging down), and that can lead to the spring disengaging, or at least to noise and to points where corrosion starts. In addition, the stacking of the turns on compression is irregular.

The invention relates to an improvement serving both to improve docking of the spring with its supports, and also to ensure that the turns stack regularly when the spring is compressed.

More particularly, the invention provides a vehicle suspension including a subassembly constituted by a coil spring mounted to bear between two supports of variable spacing, the suspension being characterized in that at least one support is constrained to move along a trajectory that is curved relative to the other, and in that the variation in the pitch of an end portion of the corresponding end turn bearing against said support is negative or zero.

Advantageously, said end turn is off-center relative to a general axis of said spring. These two characteristics are very advantageous in combination.

The shape of this end turn provides contact that is more complete (i.e. that extends over a longer length of the turn) between the end turn and the corresponding support, in particular under a light load.

The invention can be better understood and other advantages thereof appear more clearly in the light of the following description given purely by way of example and made with reference to the accompanying drawing, in which:

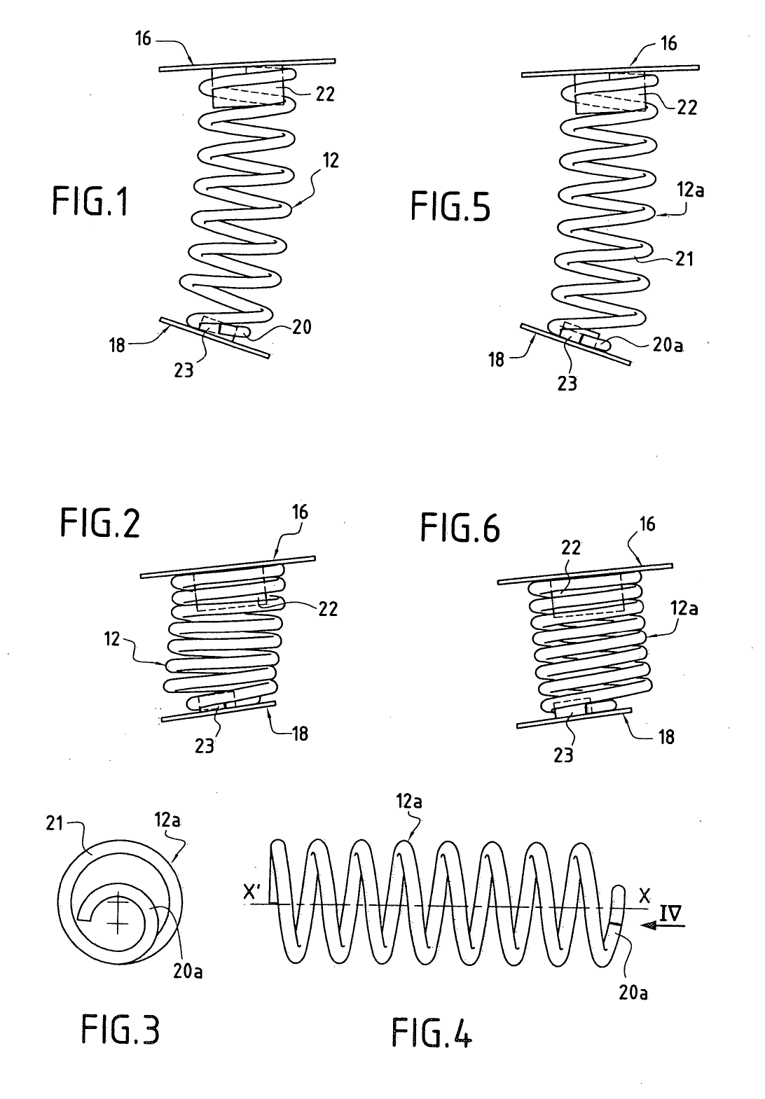

FIGS. 1 and 2 show a portion of a suspension of known type, i.e. more particularly a conventional spring mounted between two supports;

FIG. 3 is a view of a spring modified in accordance with the invention;

FIG. 4 is a view looking along arrow IV of FIG. 3; and

FIGS. 5 and 6 are views analogous to FIGS. 1 and 2 and show the positioning and the behavior of the spring modified in accordance with the invention, when extending between the two supports.

With reference to FIGS. 1 and 2, the portion of a conventional suspension shown comprises a coil spring 12 mounted to bear in compression between two supports 16 and 18 of variable spacing. The support 16 is secured to the chassis, while the other support 18 is defined by an arm, which is itself hinged to the chassis. The two supports therefore move relative to each other like the blades of a pair of scissors. In addition, the turns of the prior art spring are all coaxial when the spring is in a non-stressed state, including the end turns that are to be engaged on corresponding studs secured to the supports. As can be seen in FIG. 1, this leads in particular to poor bearing support between at least one end turn 20 and the corresponding support 18 when the spring is in a relaxed position, and this also leads to the turns stacking in irregular manner on being compressed (see FIG. 2).

The spring 12a constituting the improvement of the invention is shown in its non-stressed state in FIGS. 3 and 4. It can be seen that its pitch varies over an end portion at least of an end turn 20a in a manner that is negative. Furthermore, at least one end turn (the turn 20a in this example) is off-center relative to a general axis X′-X of the spring. In addition, it can be seen in the example shown that said end turn 20a is of a diameter than is smaller than the mean diameter of the other turns of the spring adjacent thereto. Finally, the end turn 20a is substantially tangential to a cylinder defined by the neighboring other turns 21 (of constant diameter) when the spring is in its non-stressed state, as shown in FIGS. 3 and 4.

Because of these characteristics, the spring 12a is mounted in much more satisfactory manner between the two supports, as can be seen in FIGS. 4 and 5. As in the prior art, each support has a stud 22, 23 shaped and dimensioned so as to fit in the corresponding end turn. However, as can be seen in FIG. 5, the way in which the pitch of the end turn 20a varies enables the spring to take up a much more satisfactory position between its two bearing points (as defined by the studs) with curvature that is smaller and more regular when the spring is in the relaxed state, and the end turn rests on its support over a much greater length of the turn, particularly when the spring is relaxed, as can be seen by comparing FIGS. 1 and 5. Furthermore, when the spring is compressed, the turns stack in much more regular manner, as can be seen by comparing FIGS. 2 and 6.

1-5. (canceled)

6. A vehicle suspension including a subassembly constituted by a coil spring mounted to bear between two supports of variable spacing, wherein at least one support among said two supports is constrained to move along a trajectory that is curved relative to the other support among said two supports, and wherein the variation in the pitch of an end portion of a corresponding end turn bearing against said at least one support is negative or zero.

7. A vehicle suspension according to claim 6, wherein said end turn is off-center relative to a general axis of said spring.

8. A vehicle suspension according to claim 6, wherein said end turn is of a diameter smaller than a mean diameter of other turns of said spring adjacent to said end turn.

9. A vehicle suspension according to claim 7, wherein said end turn is of a diameter smaller than a mean diameter of other turns of said spring adjacent to said end turn.

10. A vehicle suspension according to claim 8, wherein said end turn is substantially tangential to a cylinder defined by said other turns when said spring is in a non-stressed state.

11. A vehicle suspension according to claim 8, wherein said at least one support includes a stud shaped and dimensioned so as to fit in said end turn.

12. A vehicle suspension according to claim 10, wherein said at least one support includes a stud shaped and dimensioned so as to fit in said end turn.
